(19) United States
(12) Patent Application Publication
(10) Pub. No.: US 2025/0139575 A1
(43) Pub. Date: May 1, 2025

(54) MACHINE LEARNING-BASED INGREDIENT AND CRAFT COCKTAIL RECIPE RECOMMENDATION ENGINE

(71) Applicant: Stirred Inc., Oakland, CA (US)

(72) Inventors: Brian MCKILLIPS, Oakland, CA (US); Stephen GEORGE, Oakland, CA (US); Colin KLINGMAN, San Francisco, CA (US); Isaac STEINER, Chicago, IL (US); Michael CECCONI, Oakland, CA (US)

(21) Appl. No.: 18/683,508

(22) PCT Filed: Sep. 23, 2022
(86) PCT No.: PCT/US2022/044573

§ 371 Date: Feb. 13, 2024

Related U.S. Application Data
(60) Provisional application No. 63/249,481, filed on Sep. 28, 2021.

(51) Int. Cl. G06Q 10/087; G06Q 30/0601; G06V 10/82

(52) U.S. Cl. CPC G06Q 10/087; G06Q 30/0631; G06V 10/82

(57) ABSTRACT

Systems and techniques are provided for providing machine learning-based customized recommendations based on accessible ingredients to for making craft cocktails. For example, a process can include obtaining ingredient inventory information indicative of one or more ingredient items associated with a user and determining, using a trained neural network, one or more candidate recipes based on the ingredient inventory information. Based on determining that a given candidate recipe includes at least one missing ingredient item that is not included in the ingredient inventory information, a recommended substitution can be determined for the missing ingredient item. A plurality of recipe recommendations can be generated, using the trained neural network, based on the one or more candidate recipes and one or more recommended substitutions, wherein the plurality of recipe recommendations includes at least one recipe recommendation that is modified based on the recommended substitution.

### CROSS-REFERENCE TO RELATED APPLICATIONS

This application is a National Stage entry of International Application No. PCT/US2022/044573 filed Sep. 23, 2022 and entitled “MACHINE LEARNING-BASED INGREDIENT AND CRAFT COCKTAIL RECIPE RECOMMENDATION ENGINE,” which claims the benefit of priority to U.S. Provisional Patent Application No. 63/249,481 filed Sep. 28, 2021 and entitled “INGREDIENT RECOMMENDATION ENGINE,” the disclosure of which is herein incorporated by reference in its entirety.

### FIELD

The present disclosure generally relates to a system for providing recommendations, and in particular, to solutions for providing machine learning-based customized recommendations based on accessible ingredients to for making craft cocktails.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The use of a same reference numbers in different drawings indicates similar or identical items or features. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example environment in which a recommendation engine can be used, in accordance with some examples;

FIGS. 2A and 2B are flow diagrams illustrating an example of a process for generating recommendations, in accordance with some examples;

FIG. 3 is a block diagram illustrating an example of a deep learning network, in accordance with some examples;

FIG. 4 is a block diagram illustrating an example of a convolutional neural network, in accordance with some examples; and

FIG. 5 is a block diagram illustrating an example of a computing system, in accordance with some examples.

### DETAILED DESCRIPTION

Certain aspects and examples of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and examples described herein may be applied independently and some of them may be applied in combination as would be apparent to those of skill in the art. In the following description, for the purposes of explanation, specific details are set forth in order to provide a thorough understanding of aspects and examples of the disclosure. However, it will be apparent that various aspects and examples may be practiced without these specific details. The figures and description are not intended to be restrictive.

The ensuing description provides example aspects, and is not intended to limit the scope, applicability, or configuration of the disclosure. Rather, the ensuing description of the exemplary aspects will provide those skilled in the art with an enabling description for implementing examples and aspects of the disclosure. It should be understood that various changes may be made in the function and arrangement of elements without departing from the scope of the application as set forth in the appended claims.

One challenge often experienced when preparing food or beverages is the difficulty in identifying recipes that can be made with ingredients that are readily accessible. It can be similarly difficult to identify those recipes that would be makable with a combination of ingredients that are readily accessible and one or more ingredients that could be acquired with relatively low effort (e.g., via delivery, available within a preset distance from user's location, etc.). By way of example, a user may have several cocktail ingredients (e.g., at varying quantities) in their possession (e.g., in a home bar, kitchen, vacation home, etc.), but may find it difficult to ascertain the range of recipes (e.g., cocktails) that can be made with existing ingredients. Similarly, the user may be unaware of ingredient additions (that are readily obtainable) that could expand the number and/or variety of recipes that could be made or otherwise recommended. There is a need to provide information associated with additional ingredients, available recipes, and/or potentially available recipes (e.g., information such as store location, delivery options and availability, product availability, mapped display, distance data, etc.) to assist users in deciding whether to procure additional ingredients.

Aspects of the disclosed technology provide solutions to the foregoing limitations by providing methods and systems for tracking inventories of ingredients (e.g., such as cocktail ingredients), and providing information about available recipes based on current ingredients, as well as possible recipes that may be achieved with the acquisition of additional ingredients that are readably obtainable. Systems, apparatuses, processes (also referred to as methods), and computer-readable media (collectively referred to as “systems and techniques”) are described herein that can be used to determine ingredient inventory information associated with a user and make one or more automatic recommendations (e.g., makable recipe recommendations, ingredient acquisition recommendations, potentially makable recipe recommendations, ingredient substitution recommendations, recipe modification recommendations, etc.) that are based on the determined ingredient inventory information. For example, inventories of ingredients can be tracked automatically or semi-automatically, using information such as purchase history, data obtained from one or more smart tags, etc., as will be described in greater depth below.

In some embodiments, inventories of ingredients can be tracked using one or more machine learning (ML) networks and/or artificial intelligence (AI) networks. In some cases, machine vision can be used to automatically detect and classify available inventories of ingredients using one or more images captured by a camera or computing device associated with a user. For example, a user can utilize a smartphone or other mobile computing device to capture one or more images of their current inventory of ingredients (e.g., cocktail ingredients). The one or more images can be provided as input to a computer vision system and/or a trained ML network, which can detect and classify (and/or identify) one or more unique products represented in the captured images. In some examples, the computer vision system and/or trained ML network can determine one or more of a product type, a product classification or category, a product brand, a product barcode or stock keeping unit (SKU), a product size or volume, a consumption or depletion percentage or level of a given product, a percentage or volume remaining of a given product, etc.

In some embodiments, the systems and techniques described herein can be used to automatically identify ingredients that are readily available (e.g., readily available to a user). For example, readily available ingredients can be identified based on a variety of metrics and/or information, including, but not limited to, the ability (or availability) for the ingredient to be delivered to the user, distance to a point of sale where the ingredient can be purchased, and/or ingredient cost, etc. These metrics, in some examples, can be displayed on an interactive map view to provide context of the location(s) where one or more of the identified ingredients may be available. These metrics can also be linked to different applications (e.g., mobile applications, etc.) and configured for delivery of the identified ingredients.

In some examples, recipe and/or ingredient recommendations can be automatically generated based at least in part on stored user data. For example, recipe and/or ingredient recommendations can be automatically generated based on user profile data that can include, but is not limited to, indications of a user's past ingredient purchases, a current inventory of ingredients available to or otherwise associated with the user, recipes previously made and/or saved by the user, surveys, and/or user taste or preference information, etc. In some cases, recommendations may be automatically generated for a given user based on analyzing the given user's preferences and/or user information (e.g., stored in or associated with a user account linked to the given user) with corresponding user preference and user information associated with accounts that are linked to or proximate with other users. For example, the given user account and/or user preferences can be analyzed against a plurality of additional user accounts and/or corresponding user preferences to determine a similarity metric or matching criteria along one or more dimensions of similarity. In some examples, the similarity metric and/or matching criteria may be based on factors such as demographic information, geographic location information, user-provided taste preferences, etc. In one illustrative example, the similarity metric and/or matching criteria can be based on the recipe history of the given user and the recipe histories of the additional users (e.g., with a higher similarity score between the given user and additional users with a more related or overlapping recipe history). In some embodiments, a similarity metric and/or matching criteria can be based on analyzing the user accounts and corresponding user preference information of additional user accounts identified by the given user as belonging to friends or acquaintances of the given user (e.g., because a given user and his or her friends may be more likely to share similar tastes than two strangers or unrelated individuals). In some aspects, the similarity metric and/or matching criteria can include one or more weighting factors that can be used to emphasize or de-emphasize the relative importance of individual data inputs to the similarity analysis.

In some embodiments, an inventory of ingredients associated with a given user (e.g., the ingredients that are currently in the possession of the given user and/or are readily accessible to the given user) can be combined with the corresponding inventory of ingredients associated with one or more additional users, such that an automatic determination of available recipes can be generated based on the combined inventory of ingredients across the set of multiple users. For example, a recipe recommendation including certain ingredients may be more likely to be provided when it is determined that multiple users proximate to one another (e.g., within a predetermined range or location, etc.) are in possession of one or more required ingredients that are associated with or included in the recipe recommendation. In some aspects, as will be described in further detail below, ingredient and/or recipe recommendations can additionally, or alternatively, be generated based on various other contextual signals, such as contextual information regarding social events or occasions in which the user may be a participant, etc.

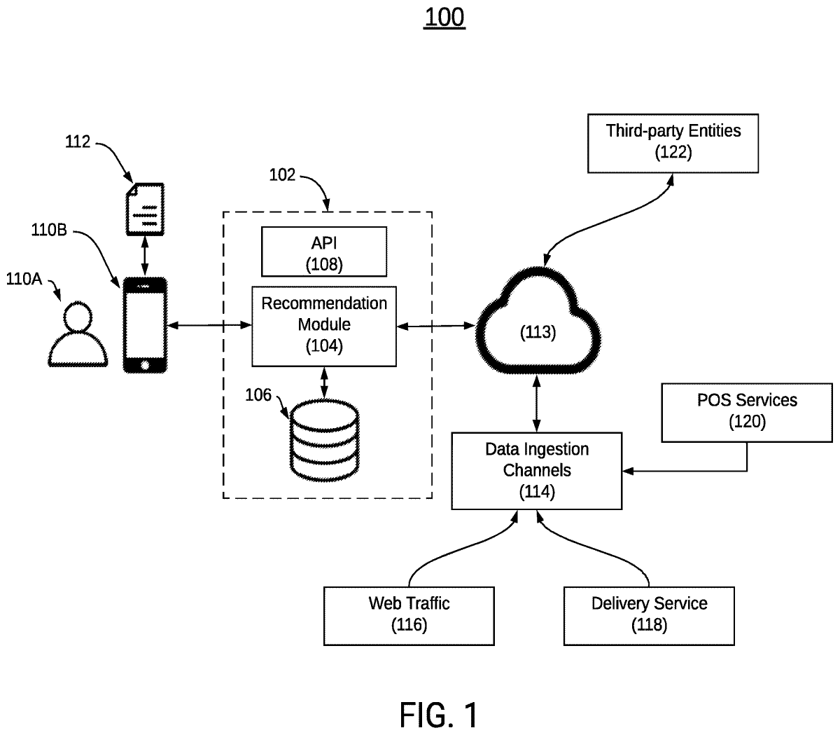

FIG. 1 illustrates an example of an environment 100 in which a recommendation engine 102 may be used to provide customized recommendations to a user 110A. As used herein, a “user” (e.g., such as user 110A) can refer to any entity and/or recipient of various recommendations generated or otherwise transmitted by the presently disclosed recommendation engine 102. By way of example, a user 110A may be a business entity, an individual, or a group of individuals, etc. User 110A can communicate with, interact with, or otherwise utilize the recommendation engine 102 via a user computing device 110n. Although user computing device 110B is illustrated as a mobile computing device (e.g., a smartphone), it is understood that various other types of network-enabled devices (such as personal computers, tablet devices) may also be utilized, without departing from the scope of the disclosed technology.

As illustrated in the example of FIG. 1, the recommendation engine 102 can include a recommendation module 104, a database 106, and one or more application programming interfaces (APIs) 108. In some embodiments, database 106 can be external relative to recommendation engine 102 and/or recommendation 102 can communicate with one or more external databases (not shown) in addition to an internally provided database 106. In one illustrative example, the recommendation module 104 can be configured to generate or otherwise provide one or more recommendations 112 (e.g., cocktail recipe recommendations) to a user, (e.g., such as user 110A, via the associated user computing device 110B). For example, the one or more recommendations 112 can include recipe recommendations (e.g., cocktail recipe recommendations based on an available inventory of ingredients associated with user 110A and/or a determined set of readily available ingredients associated with user 110A). In some examples, the one or more recommendations 112 can additionally, or alternatively, include one or more ingredient recommendations. For example, the recommendations 112 can include a recommendation for an ingredient that is not currently included in the available inventory of ingredients associated with the user, wherein the addition or acquisition of the recommended ingredient into the user's inventory would allow the user to prepare one or more identified cocktail recipes. The identified cocktail recipes associated with recommended ingredients for acquisition into the user's inventory can be automatically determined or generated based on inputs such as the user's preferences and/or preference history. For example, if the user cocktail recipe history indicates that the user has prepared a given cocktail recipe multiple times in the past month, the recommendations 112 can include a recommendation for the given cocktail recipe (e.g., if the required ingredients are available in the user's inventory or if the required ingredients or an acceptable substitute for one or more required ingredients is available in the user's inventory). If the required ingredients (or acceptable substitutes) are not all available in the user's inventory, a recommendation 112 can be automatically generated for one or more missing ingredients that, if acquired, would satisfy the requirements for preparing the given cocktail recipe.

In some examples, the recommendations 112 can include a recommendation for an ingredient that is not currently included in the available inventory of ingredients associated with the user, wherein the recommendation for the new ingredient (e.g., the ingredient not in the user's inventory) is combined with an indication of one or more cocktail recipes that would be makeable in combination with the user's current inventory if the recommended, new ingredient were to be acquired. For example, a recommendation 112 for acquiring a new ingredient can include an indication that acquiring the ingredient into the user's inventory would allow the user to prepare 15 (or some other number) new cocktail recipes, using only the acquired ingredient and the ingredients included in the user's current inventory. In some cases, the recommendations 112 can include recommendations for multiple new ingredients not currently present in the user's inventory, which in some embodiments can be ranked in order of new cocktail recipes that would become makeable with the user's current inventory of ingredients if the user were to acquire the recommended, new ingredient into the user inventory.

In some examples, recommendation module 104 can generate one or more recommendations (e.g., recipe recommendations, ingredient recommendations, etc.) using one or more trained machine learning (ML) networks. For example, one or more trained ML networks can be used to generate recommendations directly, based on inputs that may include user inventory information, user preferences and/or other user information (e.g., such as user profile and/or user account information). In some examples, the one or more trained ML networks can generate a graph representation for a set of user-specific input data (e.g., including user preferences, user ingredient and recipe history, user demographic information, and other user profile information, etc.). In some aspects, one or more graph representations can be generated to represent one or more relationships between historical user preference information and recommendations for ingredients and/or recipes that can be suggested at a current time. In some embodiments, one or more graph representations can be generated to represent one or more relationships between a given user (and the corresponding preferences/user information of the given user) and a plurality of additional users (and the corresponding preferences/user information of the additional users) in order to generate recommendations based on similarities between users.

In some aspects, representation learning (e.g., graph representation learning) can be used to generate a vector representation of user-specific data and/or one or more learned relationships. For example, a representation learning (or graph representation learning) process can generate as output an embedding space in which the user-specific data and associated learned relationships can be further analyzed, processed, manipulated, etc., to generate the presently disclosed recommendations 112. In one illustrative example, one or more ML networks can be trained to perform representation learning (e.g., graph representation learning) in order to automatically generate (and/or dynamically update or modify) a flavor/taste preference profile for a given user. In some examples, the flavor/taste preference profile can be provided as a flavor/taste preference graph. In some aspects, nodes of the flavor/taste preference graph can represent specific ingredients or ingredient combinations (e.g., recipes). In some examples, nodes of the flavor/taste preference graph can represent classifications of ingredients, types of ingredients, or other labels that may be applied to groups of similar ingredients.

For example, a given ingredient may be referred to as a primary ingredient if it is included in a given recipe; substitute ingredients are those ingredients which can be substituted for the given ingredient according to the recipe or according to a determined similarity or substitutability factor. In some aspects, relationships between different ingredients (e.g., either discrete/individual ingredients or classes/groupings of ingredients) can specify information such as substitutability, or lack thereof. In some cases, substitutability of a given ingredient can depend at least in part on the particular recipe in which the substitution is to be made. In some examples, substitutability of a given ingredient can depend on the remaining primary ingredients in the recipe in which the substitution is to be made. For example, an ingredient A may be substituted for ingredient B if ingredients C or D are also included in the recipe, but may not be substituted for ingredient B if ingredients C or D are not include in the recipe (or may not be substituted for ingredient B if an incompatible ingredient E is included in the recipe).

In some examples, one or more trained ML networks can be used to perform automatic inventory detection, recognition, and/or classification tasks. For example, a trained ML network can be used to implement one or more computer vision techniques for automatically recognizing ingredients based on analyzing user-captured images of their available ingredients. As will be described in greater depth below, the trained ML networks may include one or more neural networks for performing object detection and/or classification. In one illustrative example, the systems and techniques described herein can implement one or more trained ML networks for performing real-time object detection (e.g., for input images of user ingredients/user ingredient inventories)

In some aspects, the one or more neural networks described herein can be provided as recurrent networks, non-recurrent networks, or some combination of the two. For example, recurrent models can include, but are not limited to, recurrent neural networks (RNNs), gated recurrent units (GRUs), and long short-term memory (LSTMs). Additionally, the one or more neural networks disclosed herein can be configured as fully-connected network networks, convolutional neural networks (CNNs), or some combination of the two.

In some embodiments, the systems and techniques can utilize a pre-trained input neural network that is trained on one or more general purpose training sets that are designed for conventional object detection purposes. For example, the pre-trained input neural network can be trained to detect a wide variety of objects, without receiving training specific to detection of a certain type or class of objects (e.g., such as user ingredient inventory objects). In some examples, the pre-trained input neural network can be based on the YOLO Detection System (see “You Only Look Once: Unified, Real-Time Object Detection”, Joseph Redmon et al., University of Washington; “YOLOv3: An Incremental Improvement”, Joseph Redmon et al., University of Washington). To perform pre-training, the YOLO neural networks can be trained on one or more general purpose training data sets that cover a wide range of different object classes and classifications. For example, a pre-trained general-purpose object detection neural network based on the YOLO architecture can subsequently be trained to perform ingredient detection and/or inventory detection tasks using one or more supplemental training data sets of labeled images of the ingredients and/or inventory objects that are to be detected.

For example, when the ingredients and inventory objects that are to be detected comprise cocktail recipe ingredients, the supplemental training data sets can include labeled images of liquor bottles, mixers, juices, syrups, sodas, etc. In some aspects, the supplemental training data set can include a plurality of different images for each type of ingredient (or each unique ingredient) that is to be detected. For example, ingredient and inventory object detection may be performed based on a Universal Product Code (UPC) that is associated with each unique ingredient or inventory item. For example, a 1.75-liter bottle of liquor may be associated with a different UPC (e.g., which may also be encoded as a barcode) than a 750-milliliter bottle of the same type of liquor, and in some cases, it can be desirable to differentiate between the two different bottle sizes. For example this size differentiation may be used to perform inventory level tracking and/or to provide an input to the recommendation engine described herein—if a recipe requires 1 liter of an ingredient, but the user inventory contains only a 750 mL bottle of that ingredient, then the recipe should not be recommended (or should only be recommended in combination with an ingredient recommendation indicating that the user would be required to obtain at least the missing quantity). In some embodiments, the systems and techniques described herein can utilize one or more ML networks (e.g., neural networks, etc.) that are trained to detect and/or classify unique ingredient inventory items that are present in user captured or user provided images. In one illustrative example, the one or more ingredient inventory item detection ML networks can be trained on labeled training data that includes a plurality of example images of each unique UPC (e.g., each unique combination of inventory item and packaging/size/volume) that may be represented within the presently disclosed recommendation system.

In operation, the recommendation engine 102 is configured to ingest data from various sources. For example, the recommendation engine 102 can ingest ingredient inventory data that is associated with user 110A or otherwise indicative of the currently available ingredients that are possessed by user 110A. In some aspects, the ingested ingredient inventory data can include stock level or remaining product information for some (or all) of the ingredient items represented in the user's inventory. For example, as will be described in greater depth below, one or more trained object detection ML, networks and/or computer vision systems can be utilized to automatically recognize and classify unique inventory items and an associated remaining product amount/volume based on receiving as input one or more images of the user's current inventory items.

In one illustrative example, recommendation engine 102 can ingest data from various sources connected to or otherwise reachable via network 113 (e.g., the internet). Ingested data can be stored in database 106 (e.g., or any other applicable storage device). In some examples, ingested data may be received by the recommendation engine 102 via one or more data ingestion channels 114. For example, the data ingestion channels 114 may include, but are not limited to, one or more of web traffic signals 116 (e.g., browser cookies), delivery services data 118, and/or point-of-sale (POS) services data 120. By way of example, web traffic 116 may include various types of user web data that may be acquired via a browser, a web app, and/or a mobile app, etc. In some aspects, the user web data can be obtained from a browser, web app, mobile app, etc., that is provided on a user computing device (e.g., a computing device used by or otherwise associated with user 110A). For example, the user web data associated with web traffic signals 116 can be obtained from a web app or mobile app running on the user's mobile device 110B. In some cases, some (or all) of the web traffic data 116 may be acquired from one or more third-parties or third-party data aggregation services.

In some examples, delivery service data 118 can include data that is collected and provided by a delivery service (e.g., delivery service application, etc.). By way of example, delivery service data 118 can include purchase history information for any number of items (e.g., ingredients or other user inventory items) that have been previously purchased by user 110A. In some examples, API 108 can integrate with one or more delivery service applications to collect and ingest purchase history information, user preferences, etc. from an account of user 110A associated with the delivery service application.

In some aspects, the ingested inventory data may also be acquired by other sources, including but not limited to: manual self-selection or entry by user 110A (e.g., using a web app, mobile app, or other data entry UI associated with the presently disclosed systems and techniques), a barcode scanner, selection via a mobile application on user device 110B, previous recommendations, recommendations based on user telemetry (e.g., a user's interaction with technology), user location, bottle recognition via one or more trained ML networks and/or artificial intelligence networks, computer vision, and/or smart tags.

In some examples, user 110A can manually input information associated with the user's current inventory of ingredients (e.g., via a keyboard of user device 110B). In some examples, user 110A can input one or more ingredients (e.g., the user current ingredient inventory information/data can be ingested to the recommendation engine 102) using a barcode scanner and/or a camera function on user device 110B. In some cases, the barcode scanner can be an external device separate from the user device 110B. In some aspects, the barcode scanner can be implemented by the user device 110B (e.g., by using one or more cameras included in the user device 110B).

For example, user 110A can scan barcodes on the ingredients using a barcode scanner or the camera function on user device 110B, which in turn will be inputted via a mobile application executing on user device 110B, or the like. In some aspects, the scanned barcodes can encode a unique UPC associated with the scanned ingredient or inventory item (e.g., as described above). In one illustrative example, a camera of the user device 110B can be used to capture one or more images (or video) of the user's currently possessed ingredients/inventory items. The captured images can be analyzed to detect one or more barcodes, which can be decoded to obtain a unique UPC indicative of the ingredient type and the packaging type or size associated with the ingredient.

In some examples, a mobile application running on user device 110B can include a user interface (UI) depicting or presenting or more selectable ingredients for user input. In some examples, a user's search history or website history can be used to determine, for example, user preferences or interests. In some examples, one or more machine learning (ML) and/or artificial intelligence (AI) based approaches can be used to automatically recognize ingredients a user has in inventory. For example, camera-based activity tracking tools (e.g., computer vision) can be used to identify visual information such as bottle type, shape, quantity of product remaining in the bottle, etc. In some instances, the camera-based activity tracking can use computer vision technologies to collect data on the ingredients available, for example, in the user's liquor cabinet. In some examples, Internet-of-Things (IoT) smart tags or labels can be affixed to ingredients in a user's inventory (e.g., liquor bottle, etc.) and used to track the consumption of that ingredient. For example, through short-range wireless communications (e.g., Bluetooth, RFID, NFC, etc.), a smart tag/label can be used to determine how much liquid is in a bottle and provide information (e.g., by wireless transmitting to the user device 110B and/or another computing device associated with recommendation engine 102) indicative of the amount of liquid remaining/currently contained in the bottle. In some aspects, a smart tag/label can additionally be used to track or otherwise determine historical consumption rates of a given ingredient or inventory item, which in combination with the real-time consumption tracking data described above, can be used by the systems and techniques disclosed herein to provide automatic recommendations on when to repurchase the ingredient.

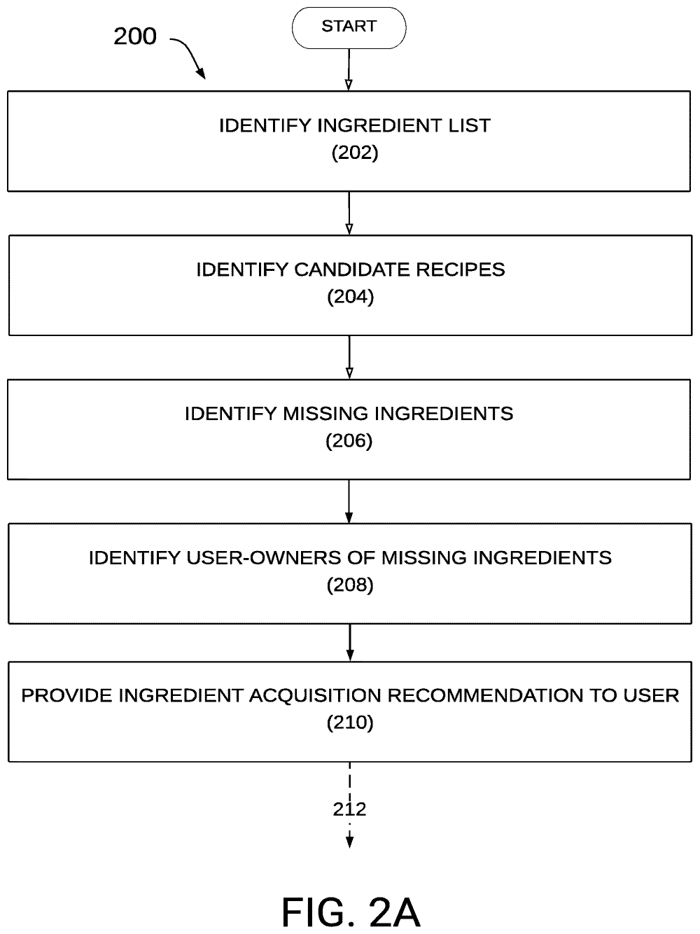

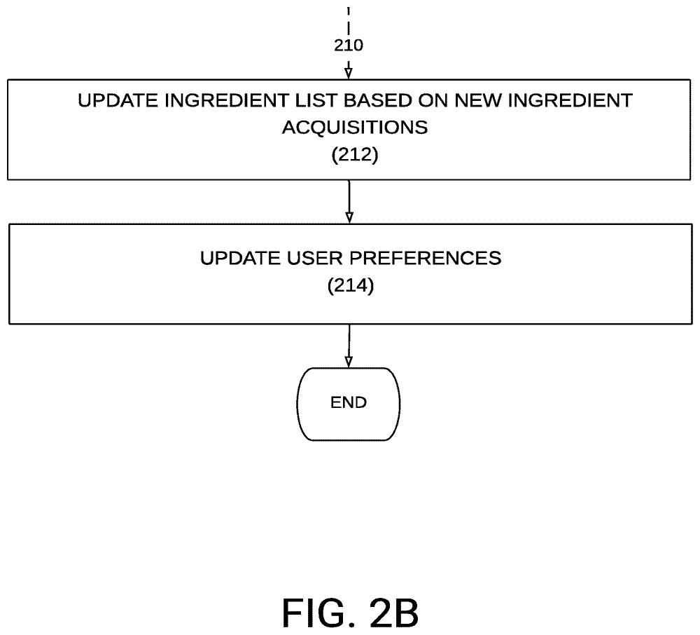

As illustrated in the example of FIG. 1, data ingestion channels 114 can also include point of sale (POS) services/data 120, which can include data collected by from retailers, for example, during the sale of one or more ingredients, such as ingredients acquired by user 110A to make various types of cocktails. In some instances, data that is collected, stored, and/or generated by recommendation engine 102 may be provided to one or more third-party entities 122, for example using an application programming interface (API) 108. An example process for determining ingredient inventory information and making one or more automatic recommendations (e.g., makable recipe recommendations, ingredient acquisition recommendations, potentially makable recipe recommendations, ingredient substitution recommendations, recipe modification recommendations, etc.) that are based on the determined ingredient inventory information is discussed in further detail with respect to the example process illustrated in FIGS. 2A and 2B, below.

FIGS. 2A and 2B illustrate steps of an example process 200 for automatically determining ingredient inventory information and making one or more automatic recommendations (e.g., makable recipe recommendations, ingredient acquisition recommendations, potentially makable recipe recommendations, ingredient substitution recommendations, recipe modification recommendations, etc.) that are based on the determined ingredient inventory information.

For example, at step 202, the process 200 includes identifying an ingredient list that is currently associated with the user. In some aspects, the ingredient list may also be referred to as the current user inventory or the user's current ingredient inventory. The ingredient list can include an itemization of all individual ingredients, such as spirits, that are available to the user. For example, the ingredient list may contain an indication of types of alcoholic spirits or other cocktail ingredients that are at the user's location or otherwise in the user's possession. In some examples, if the user is a bar or restaurant, the ingredient list may include an inventory of all ingredients owned by the bar/restaurant. The ingredient list can be determined or otherwise generated based on any of the previously mentioned criteria and information sources, for example, purchase history, web traffic, POS data, delivery service data, manual self-selection by user 110A, barcode scanner, selection via a mobile application on user device 110B, previously recommendations, recommendations based on user telemetry (e.g., a user's interaction with technology), user location, bottle recognition via one or more trained ML or AI networks, computer vision, smart tags, etc. By way of example, the ingredient list may be based on data collected (e.g., ingested data) using one or more of the data ingestion channels 114, discussed above with respect to FIG. 1. For example, the ingredient list may be determined based on purchase history information associated with a user (e.g., such as the user's POS purchase history data, obtained from POS services 120 illustrated in FIG. 1) and/or other third-party data, such as purchase history information supplied by one or more third-party retailers.

At step 204, the process 200 can include identifying one or more candidate recipes for recommendation to the user. For example, the process 200 can perform steps necessary to match available ingredients (e.g., ingredients included in the user's current ingredient inventory determined at step 202) with one or more candidate recipes that may be available to the user (e.g., makeable by the user). For example, combinations of items on the ingredient list can be used to identify recipes that can be made by the user from items on the ingredient list, without the need to acquire additional ingredients. In some examples, candidate recipes can be determined via machine learning. For example, the recommendation module 102 illustrated in FIG. 1 can implement or otherwise include one or more neural network (or the like) that can use data from database 106, including a listing of ingredients and other metrics (e.g., user profile, etc.) as input to generate or identify one or more candidate recipes. In some examples, the candidate recipes can also include recipes with missing, but readily available ingredients. In some examples, the candidate recipes can include recipes with one or more ingredients that are missing from the user's current inventory and are not readily available, when one or more ingredient substitutions are identified for the missing ingredient(s). An acceptable ingredient substitution may be a substitute ingredient that is included in the user's current inventory and/or is readily available.

In some aspects, the identified candidate recipes may be provided to the user based on a determined order of relevance. Determinations of relevance may be based on, for example, user profile information, which may include user demographic information, user purchase history information, and/or other information that is available about the user. In at least one embodiment, further determinations of relevance may be based on user taste preferences, purchasing behaviors, travel patterns, and event attendance.

By way of example, user profile information may include explicit signals/feedback provided by the user regarding his/her tastes or preferences, such as feedback regarding recipes/cocktails for which the user has indicated an affinity. User profile information can also include information (metadata) relating to past user behaviors, such as purchasing behaviors, travel patterns, event attendance, etc. In other embodiments, candidate recipes may be based on contextual information relating to the time and/or environment in which the user is situated. By way of example, contextual information may include information regarding a particular cultural event or theme, such as seasonal holidays, or other social events (e.g., weddings, birthdays, or celebratory occasions).

At step 206, the process 200 can include identifying any missing ingredients (e.g., not included in the user's current inventory) for each respective candidate recipe identified at step 204. For example, the process 200 can perform steps necessary to identify recipes for which nearly all of the ingredients are available to the user, but one or more ingredients are missing. These recipes can be representative of cocktails the user may wish to explore, and can be realized with the acquisition of minimal ingredients. In some embodiments, these candidate recipes may be presented in an order based on the number of additionally needed ingredients. For example, recipes for which only one additional ingredient is necessary can be presented before (or given primacy to) recipes for which three additional ingredients are needed.

An alternate ingredient list can also be generated. An item is an alternate for the original item if the item's ingredient is an alternate for the original ingredient and is the best match. The best match is determined by giving greater preference or weight to items that are the same ingredient type as the original item but not already in the recipe. Items deemed a best match due to a greater weight will be presented to the user. For example, if a recipe calls for agave syrup, the user has simple syrup, then simple syrup can be an alternate ingredient provided.

In some embodiments, one or more additional factors may also be taken into consideration and analyzed in at least step 206. For example, the one or more additional factors may include factors such as ease of ingredient acquisition and/or ingredient cost, etc. In some embodiments, ingredients may be recommended based on user profile information, such as by giving greater preference or weight to certain ingredients based on known user preferences. For example, one or more ingredients can be identified as having a relatively strong or relatively high user preference (e.g., based on the user flavor/taste preference graph previously described above)—candidate recipes that include ingredients that are more closely aligned with the determined user flavor/taste preferences can be given a greater weight in the recommendations generated by recommendation engine 102. In some aspects, the user flavor/taste preference graph can be used to determine recommendations for new ingredients that a user has not yet tried (e.g., are not currently in the user's inventory and have not historically been present in the user's inventory), but that the user may enjoy based on their unique flavor/taste preference graph.

In other instances, ingredient recommendations can be based, at least in part, on contextual information associated with a time and/or place of the user. For example, if it is known that the user is attending a holiday event, different ingredients may be recommended than if he/she were attending a sporting event. In another example, if a first user is at a second user's location, the first user's recommendation can include the second user's ingredients and any specific ingredients the first user has indicated as having.

At step 208, the process 200 can include steps for identifying how to procure the missing ingredient(s). In some examples, the missing ingredients can be located at stores or delivery services within a predetermined distance from the location of the user. In some examples, substitute ingredients can be determined. In some examples, one or more individuals in the user's social circle that may be in possession of necessary or missing ingredients. In some embodiments, the identification of user-owners of missing ingredients can be based on social mapping information. This includes the ability to sync accounts with other users to determine what you can make between/among the multiple accounts. For example, if it is known that the user is friends with another user in possession of an ingredient that is necessary for a recommendation, then the other user and ingredient may be identified. In some instances, event information (e.g., calendar invite lists, etc.) may help to further inform such recommendations. For example, if it is determined that a friend of the user is attending a common event (e.g., a birthday party, engagement party, etc.), then that friend (user-owner) may be identified so that community-owned ingredients can be combined to make recommendations.

At step 210, the process 200 can include providing one or more ingredient acquisition recommendations to the user. For example, the ingredient acquisition recommendations can be generated or otherwise determined based on the identification of missing ingredients performed at step 206 and/or the identification of user-owners of missing ingredients at step 208. In one illustrative example, one or more ingredient acquisition recommendations can be provided to the user. The ingredient acquisition recommendations can include indications of where the user may be able to easily acquire a particular ingredient that is the subject of an ingredient acquisition recommendation, for example at a retail location, or via a specialized delivery service, as well as indications of particular friends/acquaintances (e.g., in the user's social network, address book, contacts list, etc.) that may be able to supply the missing ingredients. For example, different options can be provided to the user on the mobile application executed on user device 110B. In some examples, the different options can be provided via an a selectable list, In other examples, the different options can be displayed on a map view, illustrated the location of stores that have the missing ingredient or location of a user that has the missing ingredient.

Referring to FIG. 2B, at step 212, the process 200 can include steps for updating the user's ingredient list (e.g., updating the user's current inventory of ingredients) based on determining that the user has obtained one or more newly acquired ingredients. In some examples, the newly acquired ingredients can be ingredients that are acquired based on an ingredient acquisition recommendation, as described with respect to step 210. In some cases, the newly acquired ingredients may additionally, or alternatively, be acquired by the user independent of the one or more ingredient acquisition recommendations of step 210. As discussed above, the ingredient list may be automatically updated, for example, using ingested third-party sales data, computer vision, smart tags, barcode scanners, camera of mobile device, etc. Additionally, the user's ingredient list may be updated manually by the user, for example, in response to indications of newly acquired ingredients that are provided by the user. In some instances, the user may provide further feedback indicating their likes/dislikes or affinity for newly created recipes (cocktails). Such information can then be used to automatically update the user preference information (step 214) used by the recommendation engine.

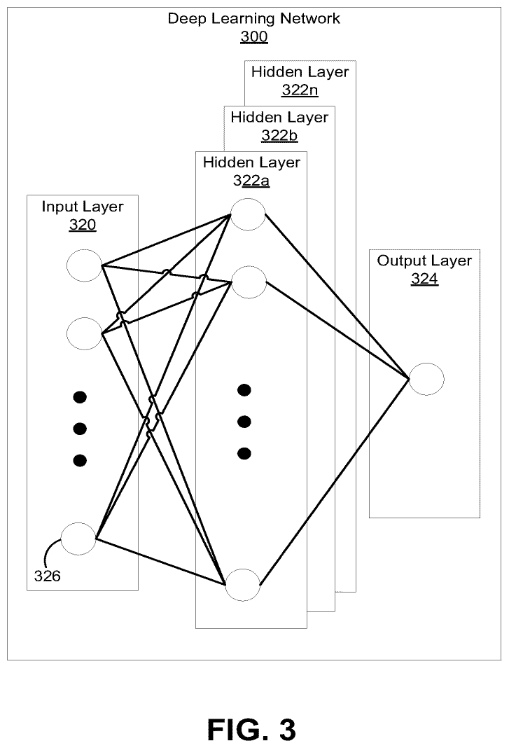

FIG. 3 is an illustrative example of a deep learning neural network 300 that can be used by a recommendation engine such as recommendation engine 102 illustrated in FIG. 1. As illustrated, an input layer 320 of deep learning neural network 300 includes or otherwise receives input data. In one illustrative example, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In one illustrative example, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [00 1 0000000].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

For the example of identifying objects in images, the forward pass can include passing a training image through the neural network 300. The weights are initially randomized before the neural network 300 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 300, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 300 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 300 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - {η}^{\frac{dL}{dW}} ,$$

where w denotes a weight, wᵢ, denotes the initial weight, and η denotes a learning rate. The learning rate can be set to any suitable value, with a high learning rate including larger weight updates and a lower value indicating smaller weight updates.

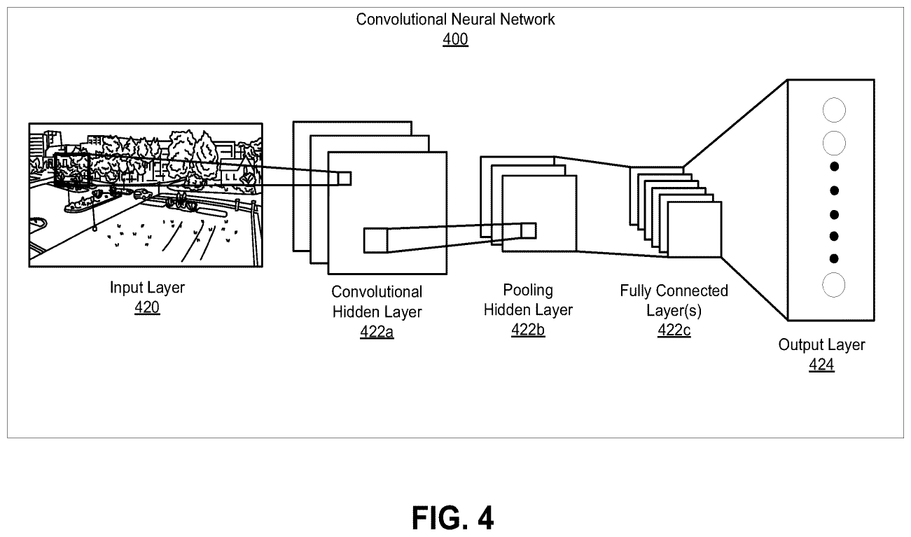

The neural network 300 can include any suitable deep network. One example includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, one of ordinary skill will appreciate that multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is one example of a function performed by a pooling hidden layer. Other forms of pooling functions be used by the pooling hidden layer 422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class, and can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 424 can include an M-dimensional vector (in the prior example, A4=10), where M can include the number of classes that the program has to choose from when classifying the object in the image. Other example outputs can also be provided. Each number in the N-dimensional vector can represent the probability the object is of a certain class. In one illustrative example, if a 4-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

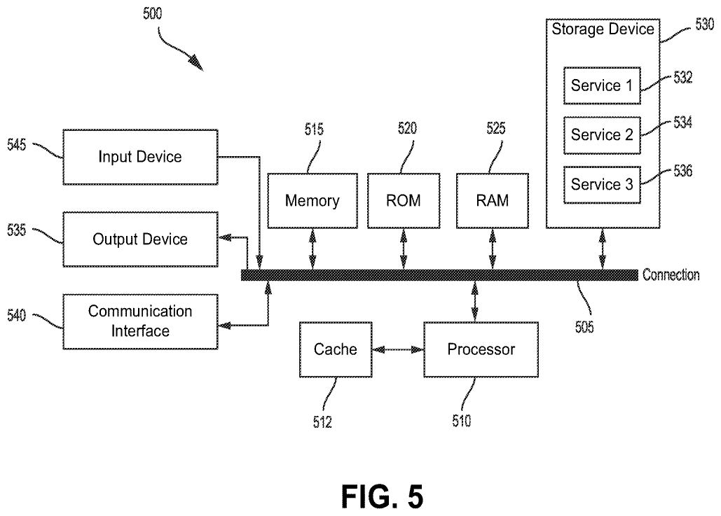

FIG. 5 illustrates an example processor-based system with which some embodiments of the subject technology can be implemented. Specifically, FIG. 5 illustrates system architecture 500 wherein the components of the system are in electrical communication with each other using a bus 505. System architecture 500 can include a processing unit (CPU or processor) 510, as well as a cache 512, that are variously coupled to system bus 505. Bus 505 connects various system components including a non-transitory computer-readable storage medium 515, (e.g., read only memory (ROM) 520 and random-access memory (RAM) 525, to processor 510.

System architecture 500 can include a cache of high-speed memory connected directly with, in close proximity to, or integrated as part of the processor 510. System architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. Memory 515 can include multiple different types of memory with different performance characteristics. Processor 510 can include any general-purpose processor and a hardware module or software module, such as module 1 (332), module 2 (334), and module 5 (336) stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system architecture 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms. In some instances, multimodal systems can enable a user to provide multiple types of input to communicate with the computing system architecture 500. Communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 can include software modules 532, 534, 536, for controlling processor 510. Other hardware or software modules are contemplated. Storage device 530 can be connected to the system bus 505. In one aspect, a hardware module that performs a particular function can include the software component stored in a computer-readable medium in connection with the necessary hardware components, such as the processor 510, bus 505, output device 535, and so forth, to carry out various functions of the disclosed technology.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of a set indicates that one member of the set or multiple members of the set satisfy the claim.

Illustrative examples of the disclosure include:

Aspect 1: A method comprising: obtaining ingredient inventory information indicative of one or more ingredient items associated with a user; determining, using a trained neural network, one or more candidate recipes based on the ingredient inventory information, wherein at least a portion of the respective ingredient items associated with each candidate recipe are included in the ingredient inventory information; based on determining that a given candidate recipe includes at least one missing ingredient item, wherein the missing ingredient item is not included in the ingredient inventory information, determining a recommended substitution for the missing ingredient item; and generating, using the trained neural network, a plurality of recipe recommendations based on the one or more candidate recipes and one or more recommended substitutions, wherein the plurality of recipe recommendations includes at least one recipe recommendation that is modified based on the recommended substitution.

Aspect 2: The method of Aspect 1, wherein the recommended substitution is an ingredient item included in the ingredient inventory information.

Aspect 3: The method of Aspect 2, wherein determining the recommended substitution for the missing ingredient item further comprises: analyzing the ingredient inventory information to determine multiple substitution candidates; and selecting the recommended substitution from the multiple substitution candidates.

Aspect 4: The method of Aspect 3, wherein selecting the recommended substitution from the multiple substitution candidates is based on one or more of user flavor preference information and user purchase history information.

Aspect 5: The method of any of Aspects 1 to 4, wherein obtaining the ingredient inventory information comprises: obtaining one or more images from a mobile computing device associated with the user; analyzing each respective image of the one or more images to identify a barcode included in the respective image; and decoding the barcode to determine a unique inventory item identifier.

Aspect 6: The method of Aspect 5, wherein the unique inventory item identifier is a Universal Product Code (UPC).

Aspect 7: The method of any of Aspects 5 to 6, further comprising updating the ingredient inventory information to include an inventory item associated with the unique inventory item identifier, wherein the ingredient inventory information is updated to include at least a product type of the inventory item and an available quantity of the inventory item.

Aspect 8: The method of Aspect 7, wherein the available quantity of the inventory item is determined based on analyzing the one or more images using an object detection neural network, wherein the object detection neural network is trained to detect one or more of a remaining volume or a liquid level of inventory items depicted in an input image.

Aspect 9: The method of any of Aspects 1 to 8, wherein obtaining the ingredient inventory information is based on data collected using one or more data ingestion channels, wherein the one or more data ingestion channels include one or more of a web service, a delivery service, or a point of sale (POS) service.

Aspect 10: The method of any of Aspects 1 to 9, wherein determining the one or more candidate recipes based on the ingredient inventory information comprises excluding, from the candidate recipes, one or more recipes that do not satisfy a selected condition.

Aspect 11: The method of Aspect 10, wherein the selected condition is an availability condition requiring that each ingredient included in a given recipe be included in the ingredient inventory information.

Aspect 12: The method of any of Aspects 1 to 11, further comprising generating a weighted ranking of candidate recipes that each include at least one missing ingredient item, wherein the candidate recipes are ranked based on a quantity of missing ingredient items.

Aspect 13: The method of Aspect 12, wherein the weighted ranking is indicative of an order of relevance for the candidate recipes determined based on user profile information.

Aspect 14: The method of Aspect 13, wherein the user profile information includes demographic information, user purchase history information, or third-party information associated with the user.

Aspect 15: An apparatus comprising: at least one memory; and at least one processor coupled to the at least one memory, the at least one processor configured to: obtain ingredient inventory information indicative of one or more ingredient items associated with a user; determine, using a trained neural network, one or more candidate recipes based on the ingredient inventory information, wherein at least a portion of the respective ingredient items associated with each candidate recipe are included in the ingredient inventory information; based on determining that a given candidate recipe includes at least one missing ingredient item, wherein the missing ingredient item is not included in the ingredient inventory information, determine a recommended substitution for the missing ingredient item; and generate, using the trained neural network, a plurality of recipe recommendations based on the one or more candidate recipes and one or more recommended substitutions, wherein the plurality of recipe recommendations includes at least one recipe recommendation that is modified based on the recommended substitution.

Aspect 16: The apparatus of Aspect 15, wherein the recommended substitution is an ingredient item included in the ingredient inventory information.

Aspect 17: The apparatus of Aspect 16, wherein to determine the recommended substitution for the missing ingredient item, the at least one processor is further configured to: analyze the ingredient inventory information to determine multiple substitution candidates; and select the recommended substitution from the multiple substitution candidates.

Aspect 18: The apparatus of Aspect 17, wherein selecting the recommended substitution from the multiple substitution candidates is based on one or more of user flavor preference information and user purchase history information.

Aspect 19: The apparatus of any of Aspects 15 to 18, wherein to obtain the ingredient inventory information, the at least one processor is configured to: obtain one or more images from a mobile computing device associated with the user; analyze each respective image of the one or more images to identify a barcode included in the respective image; and decode the barcode to determine a unique inventory item identifier.

Aspect 20: The apparatus of Aspect 19, wherein the unique inventory item identifier is a Universal Product Code (UPC).

Aspect 21: The apparatus of any of Aspects 19 to 20, wherein the at least one processor is further configured to update the ingredient inventory information to include an inventory item associated with the unique inventory item identifier, wherein the ingredient inventory information is updated to include at least a product type of the inventory item and an available quantity of the inventory item.

Aspect 22: The apparatus of Aspect 21, wherein the available quantity of the inventory item is determined based on analyzing the one or more images using an object detection neural network, wherein the object detection neural network is trained to detect one or more of a remaining volume or a liquid level of inventory items depicted in an input image.

Aspect 23: The apparatus of any of Aspects 15 to 22, wherein obtaining the ingredient inventory information is based on data collected using one or more data ingestion channels, wherein the one or more data ingestion channels include one or more of a web service, a delivery service, or a point of sale (POS) service.

Aspect 24: The apparatus of any of Aspects 15 to 23, wherein to determine the one or more candidate recipes based on the ingredient inventory information, the at least one processor is configured to exclude, from the candidate recipes, one or more recipes that do not satisfy a selected condition.

Aspect 25: The apparatus of Aspect 24, wherein the selected condition is an availability condition requiring that each ingredient included in a given recipe be included in the ingredient inventory information.

Aspect 26: The apparatus of any of Aspects 15 to 25, wherein the at least one processor is further configured to generate a weighted ranking of candidate recipes that each include at least one missing ingredient item, wherein the candidate recipes are ranked based on a quantity of missing ingredient items.

Aspect 27: The apparatus of Aspect 26, wherein the weighted ranking is indicative of an order of relevance for the candidate recipes determined based on user profile information.

Aspect 28: The apparatus of Aspect 27, wherein the user profile information includes demographic information, user purchase history information, or third-party information associated with the user.

Aspect 29: An apparatus comprising: at least one memory; and at least one processor coupled to the at least one memory, wherein the at least one processor is configured to perform operations in accordance with any one of Aspects 1 to 28.

Aspect 30: An apparatus comprising means for performing operations in accordance with any one of Aspects 1 to 28.

Aspect 31: A non-transitory computer-readable medium having stored thereon instructions that, when executed by one or more processors, cause the one or more processors to perform operations according to any one of Aspects 1 to 28.

What is claimed is:

1. A method comprising:
obtaining ingredient inventory information indicative of one or more ingredient items associated with a user;
determining, using a trained neural network, one or more candidate recipes based on the ingredient inventory information, wherein at least a portion of the respective ingredient items associated with each candidate recipe are included in the ingredient inventory information;
based on determining that a given candidate recipe includes at least one missing ingredient item, wherein the missing ingredient item is not included in the ingredient inventory information, determining a recommended substitution for the missing ingredient item; and
generating, using the trained neural network, a plurality of recipe recommendations based on the one or more candidate recipes and one or more recommended substitutions, wherein the plurality of recipe recommendations includes at least one recipe recommendation that is modified based on the recommended substitution.

2. The method of claim 1, wherein the recommended substitution is an ingredient item included in the ingredient inventory information.

3. The method of claim 2, wherein determining the recommended substitution for the missing ingredient item further comprises:
analyzing the ingredient inventory information to determine multiple substitution candidates; and
selecting the recommended substitution from the multiple substitution candidates.

4. The method of claim 3, wherein selecting the recommended substitution from the multiple substitution candidates is based on one or more of user flavor preference information and user purchase history information.

5. The method of claim 1, wherein obtaining the ingredient inventory information comprises:
obtaining one or more images from a mobile computing device associated with the user; analyzing each respective image of the one or more images to identify a barcode included in the respective image; and
decoding the barcode to determine a unique inventory item identifier.

6. The method of claim 5, wherein the unique inventory item identifier is a Universal Product Code (UPC).

7. The method of claim 5, further comprising updating the ingredient inventory information to include an inventory item associated with the unique inventory item identifier, wherein the ingredient inventory information is updated to include at least a product type of the inventory item and an available quantity of the inventory item.

8. The method of claim 7, wherein the available quantity of the inventory item is determined based on analyzing the one or more images using an object detection neural network, wherein the object detection neural network is trained to detect one or more of a remaining volume or a liquid level of inventory items depicted in an input image.

9. The method of claim 1, wherein obtaining the ingredient inventory information is based on data collected using one or more data ingestion channels, wherein the one or more data ingestion channels include one or more of a web service, a delivery service, or a point of sale (POS) service.

10. The method of claim 1, wherein determining the one or more candidate recipes based on the ingredient inventory information comprises excluding, from the candidate recipes, one or more recipes that do not satisfy a selected condition.

11. The method of claim 10, wherein the selected condition is an availability condition requiring that each ingredient included in a given recipe be included in the ingredient inventory information.

12. The method of claim 1, further comprising generating a weighted ranking of candidate recipes that each include at least one missing ingredient item, wherein the candidate recipes are ranked based on a quantity of missing ingredient items.

13. The method of claim 12, wherein the weighted ranking is indicative of an order of relevance for the candidate recipes determined based on user profile information.

14. The method of claim 13, wherein the user profile information includes demographic information, user purchase history information, or third-party information associated with the user.

15. An apparatus comprising means for performing operations in accordance with any one of the methods of claims 1 to 14.
